(19) United States
(12) Patent Application Publication
(10) Pub. No.: US 2025/0294547 A1
(43) Pub. Date: Sep. 18, 2025

(54) Multi-Panel Simultaneous PUSCH Transmission

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Huaning NIU, San Jose, CA (US); Seyed Ali Akbar FAKOORIAN, San Diego, CA (US); Sigen YE, San Diego, CA (US); Wei ZENG, Saratoga, CA (US); Yushu ZHANG, Beijing (CN)

(21) Appl. No.: 18/858,818

(22) PCT Filed: Apr. 29, 2022
(86) PCT No.: PCT/CN2022/090576

§ 371 Date: Oct. 22, 2024

(51) Int. Cl. H04W 72/1268; H04W 8/08

(52) U.S. Cl. CPC H04W 72/1268; H04W 8/08

(57) ABSTRACT

A user equipment (UE) configured with multi-panel simultaneous physical uplink shared channel (PUSCH) transmission with spatial domain multiplexing (SDM). The UE is configured to receive sounding reference signal (SRS) configuration information from a base station, transmit a first beam using a first panel of the UE, wherein the first beam comprises at least one of SRS or PUSCH and transmit a second beam using a second panel of the UE, wherein the second beam comprises at least one of SRS or PUSCH and wherein the first beam and the second beam are transmitted simultaneously.

### TECHNICAL FIELD

The present disclosure generally relates to communication, and in particular, to the multi-panel simultaneous PUSCH transmission.

### BACKGROUND

A fifth generation (5G) new radio (NR) network may support multi-panel simultaneous physical uplink shared channel (PUSCH) transmission with spatial domain multiplexing (SDM). There is a need for techniques configured to enhance support for this type of multi-panel PUSCH operation.

### SUMMARY

Some exemplary embodiments are related to a processor of a user equipment (UE) configured with multi-panel simultaneous physical uplink shared channel (PUSCH) transmission with spatial domain multiplexing (SDM), the processor configured to perform operations. The operations include receiving sounding reference signal (SRS) configuration information from a base station, transmitting a first beam using a first panel of the UE, wherein the first beam comprises at least one of SRS or PUSCH and transmitting a second beam using a second panel of the UE, wherein the second beam comprises at least one of SRS or PUSCH and wherein the first beam and the second beam are transmitted simultaneously.

Other exemplary embodiments are related to a user equipment (UE) configured with multi-panel simultaneous physical uplink shared channel (PUSCH) transmission with spatial domain multiplexing (SDM) having a transceiver configured to communicate with a network and a processor communicatively coupled to the transceiver and configured to perform operations. The operations include receiving sounding reference signal (SRS) configuration information from a base station, transmitting a first beam using a first panel of the UE, wherein the first beam comprises at least one of SRS or PUSCH and transmitting a second beam using a second panel of the UE, wherein the second beam comprises at least one of SRS or PUSCH and wherein the first beam and the second beam are transmitted simultaneously.

Still further exemplary embodiments are related to a processor of a base station configured to support multi-panel simultaneous physical uplink shared channel (PUSCH) transmission with spatial domain multiplexing (SDM) by a user equipment (UE), the processor configured to perform operations. The operations include transmitting sounding reference signal (SRS) configuration information to the UE, receiving a first beam from a first panel of the UE, wherein the first beam comprises at least one of SRS or PUSCH and receiving a second beam from a second panel of the UE, wherein the second beam comprises at least one or SRS or PUSCH and wherein the first beam and the second beam are transmitted simultaneously.

Additional exemplary embodiments are related to a base station configured to support multi-panel simultaneous physical uplink shared channel (PUSCH) transmission with spatial domain multiplexing (SDM) by a user equipment (UE), having a transceiver configured to communicate with the UE and a processor communicatively coupled to the transceiver and configured to perform operations. The operations include transmitting sounding reference signal (SRS) configuration information to the UE, receiving a first beam from a first panel of the UE, wherein the first beam comprises at least one of SRS or PUSCH and receiving a second beam from a second panel of the UE, wherein the second beam comprises at least one or SRS or PUSCH and wherein the first beam and the second beam are transmitted simultaneously.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for multi-panel simultaneous physical uplink shared channel (PUSCH) transmission with spatial domain multiplexing (SDM) according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques configured to enhance support for multi-panel simultaneous physical uplink shared channel (PUSCH) transmission with spatial domain multiplexing (SDM).

The exemplary embodiments are described with regard to a user equipment (UE) that supports multi-panel simultaneous PUSCH transmission with SDM. The exemplary UE described herein may be equipped with multiple panels each comprising one or more antenna elements. However, reference to a UE is merely provided for illustrative purposes. The exemplary embodiments may be utilized with any electronic component that may establish a connection to a network and is configured with the hardware, software, and/or firmware to support multi-panel simultaneous PUSCH transmission with SDM. Therefore, the UE as described herein is used to represent any appropriate type of electronic component.

The exemplary embodiments are also described with regard to a fifth generation (5G) New Radio (NR) network that supports multi-panel simultaneous PUSCH transmission with SDM. However, reference to a 5G NR network is merely provided for illustrative purposes. The exemplary embodiments may be utilized with any appropriate type of network that supports multi-panel simultaneous PUSCH transmission with SDM.

In addition, the exemplary embodiments are described with regard to different aspects of beam management. Those skilled in the art will understand that beam management encompasses various different types of operations including, but not limited to beam measurements, beam determination, beam reporting, beam failure detection and candidate beam detection. In some embodiments, a downlink based beam management scheme may be utilized where the base station transmits synchronization signal (SS) blocks and/or reference signals that are measured by the UE. The network and/or the UE may then select the one or more beams that are to be used for the subsequent PUSCH transmissions. In other embodiments, an uplink based beam management scheme may be utilized where the UE transmits sounding reference signal (SRS) to the base station. The network and/or the UE may then select the one or more beams that are to be used for the subsequent PUSCH transmissions.

As will be described in more detail below, the exemplary embodiments include techniques specific to downlink based beam management, techniques specific to uplink based beam management and techniques that may be used with either scheme. The exemplary techniques introduced herein may be used independently from one another, in conjunction with other currently implemented beam management mechanisms in conjunction with future implementations of beam management mechanisms or independently from other beam management mechanisms.

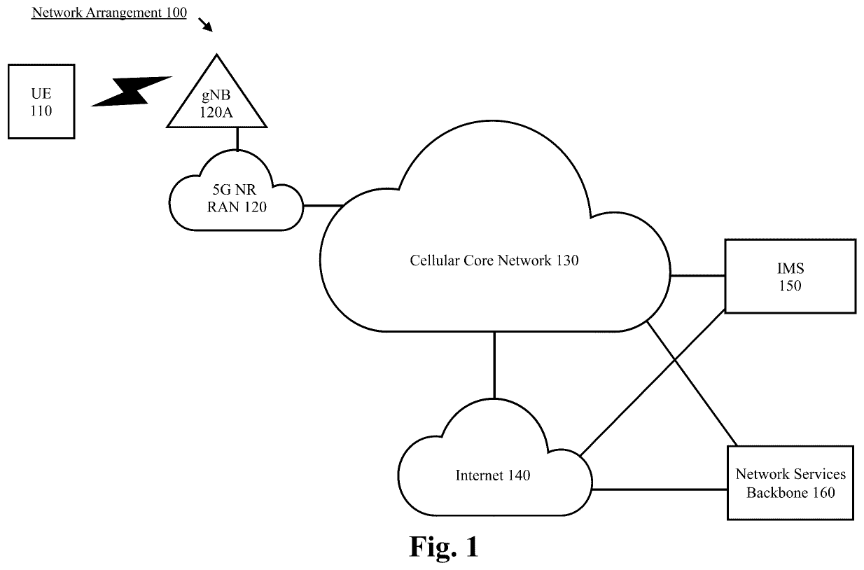

FIG. 1 shows an exemplary network arrangement 100

according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generate RAN (NG-RAN), a legacy cellular network, a wireless local area network (WLAN), etc.) and the UE 110 may also communicate with networks over a wired connection. Therefore, the UE 110 may have a 5G NR chipset to communicate with the NR RAN 120 and, optionally, any other appropriate type of chipset to communicate with other types of networks.

The 5G NR RAN 120 may be a portion of a cellular network that may be deployed by a network carrier (e.g., Verizon, AT&T, Sprint, T-Mobile, etc.). The 5G NR RAN 120 may include cells and base stations that are configured to send and receive traffic from UEs that are equipped with the appropriate cellular chip set. In this example, the 5G NR RAN 120 includes the gNB 120A. However, reference to a gNB is merely provided for illustrative purposes, the exemplary embodiments may be utilized with any appropriate type of access node may be (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the

Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

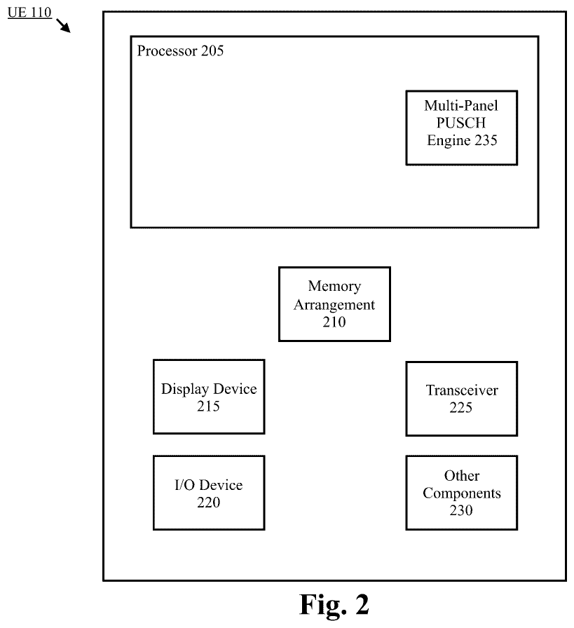

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may, for example, multiple panels each comprising one or more antenna elements, an audio input device, an audio output device, a power supply, a data acquisition device, ports to electrically connect the UE 110 to other electronic devices, etc.

The processor 205 may be configured to execute a plurality of engines of the UE 110. For example, the engines may include a multi-panel PUSCH engine 235. The multi-panel PUSCH engine 235 may perform various operations related to the configuration and performance of multi-panel simultaneous PUSCH transmission with SDM.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

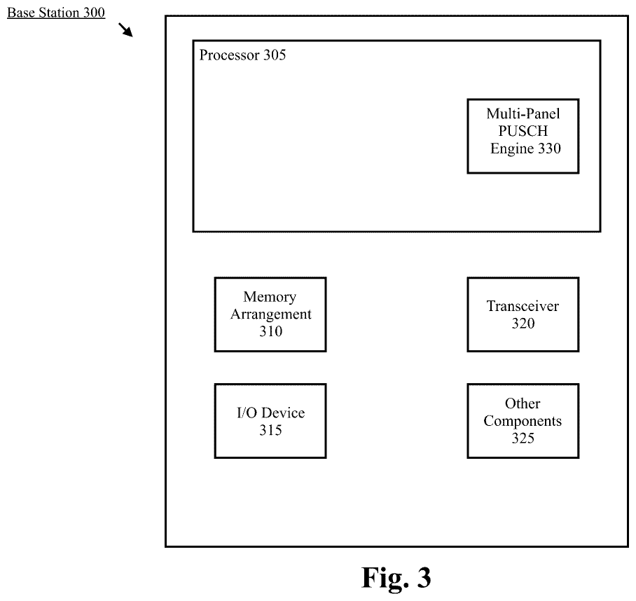

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a multi-panel PUSCH engine 330. The multi-panel PUSCH engine 330 may perform various operations related to the configuration and performance of multi-panel simultaneous PUSCH transmission with SDM by the UE 110.

The above noted engine 330 being an application (e.g.,

a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

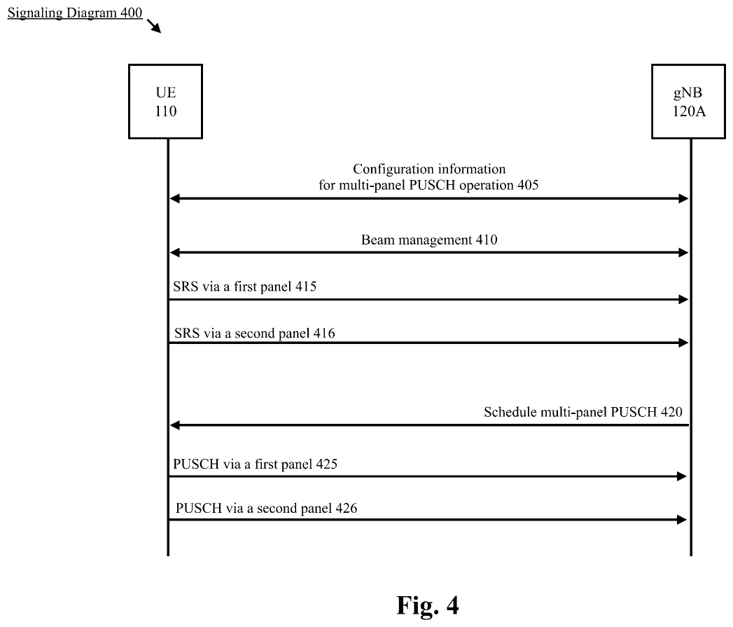

FIG. 4 shows a signaling diagram 400 for multi-panel simultaneous PUSCH transmission with SDM according to various exemplary embodiments. The signaling diagram 400 provides a general overview of the type of interactions that may occur between the UE 110 and the gNB 120A to enable the UE 110 to perform multi-panel simultaneous PUSCH transmission with SDM. The exemplary techniques introduced herein with be described in more detail below throughout the description of the signaling diagram 400.

5G NR uplink communications may support two different multiple input multiple output (MIMO) operation modes. A first MIMO mode may be characterized as codebook based uplink where the UE transmits SRS resources with multiple ports and the network schedules PUSCH by indicating a SRS resource indicator (SRI), a transmit precoding matrix (TPMI) and rank indication (RI) to the UE 110. In some embodiments, the network may configure codebook based PUSCH at the UE 110 by setting one or more parameters of an SRS-ResourceSet information element (IE) in a radio resource control (RRC) message to “codebook.” A second MIMO mode may be characterized as non-codebook based uplink where the UE 110 transmits SRS resources each with a single port and the network schedules PUSCH by indicating the SRS resource/port selection. In some embodiments, the network may configure non-codebook based PUSCH at the UE 110 by setting one or more parameters of an SRS-ResourceSet IE in an RRC message to “nonCodebook.” Some of the exemplary embodiments described below are specific to codebook based PUSCH, specific to non-codebook based PUSCH or may be used by either codebook or non-codebook based PUSCH.

In 405, the UE 110 and the gNB 120A exchange configuration information related to multi-panel PUSCH operation. For instance, consider a scenario in which the UE 110 is camped on a cell of the gNB 120A. Prior to and/or during an RRC connection between the UE 110 and the gNB 120A, the UE 110 and the network may exchange a wide variety of different types of configuration information. For example, the UE 110 and the network my exchange RRC messages. This may include the UE 110 reporting capability information that indicates the UE 110 capabilities with regard to multi-panel PUSCH operation. In addition, the network may transmit RRC configuration information to the UE 110 to configure different aspects of multi-panel PUSCH such as, but not limited to, PUSCH configuration and SRS resource sets.

In addition to multi-panel simultaneous PUSCH transmission, the UE 110 may be configured with a maximum number of MIMO layers for PUSCH operation that is less than a maximum number of ports used for uplink transmission. In this type of scenario, the UE 110 may report one or more of the following types of UE capability information to the network. For example, the UE 110 may report UE capability information to the network that indicates whether the UE 110 supports transmitting an SRS resources simultaneously from both panels. In addition, the UE 110 may further report UE capability information that indicates a maximum number of MIMO layers for PUSCH operation across both panels. The UE 110 may also report UE capability information that indicates a maximum number of ports for uplink transmission for each panel and whether an SRS resource or SRS resource set is configured separately for each panel. This may be used when SRS resources or resource sets are to be transmitted from only one of the panels. The UE 110 may also report UE capability information that indicates a maximum number of ports for uplink transmission across both panels. This may be used when SRS resources or resource sets are to be transmitted simultaneously from both panels.

In some exemplary embodiments, the UE capability information related to multi-panel simultaneous PUSCH transmission may be reported per feature set per component carrier (FSPC). Those skilled in the art will understand that FSPC means that capability information is signaled per feature set per component carrier (per CC per band per band combination). In other exemplary embodiments, the UE capability information related to multi-panel simultaneous PUSCH transmission may be reported per feature set (FS). Those skilled in the art will understand that FS means that that capability information is signaled per feature set (per band per band combination).

In 410, the UE 110 and the gNB 120A perform beam management. As mentioned above, beam management encompasses various different types of operations including, but not limited to beam measurements, beam determination, beam reporting, beam failure detection and candidate beam detection. Various exemplary techniques introduced below are related to the configuration and/or performance of beam management operations that may enable multi-panel simultaneous PUSCH transmission with SDM at the UE 110.

According to some aspects, the exemplary embodiments introduce an indication that may be sent by the UE 110 to the gNB 120A to indicate one or more sets of two beams that may be used for uplink transmission simultaneously. For downlink based beam management, the UE 110 may perform measurements on SS blocks and/or channel state interference (CSI)-reference signal (RS) to identify suitable beams for uplink transmission. The UE 110 may then perform group based beam reporting where the UE 110 groups uplink beams, downlink beams and/or beam pairs into a subset of beams. In this example, each beam group may include two beams that may be used by the UE 110 to perform multi-panel simultaneous uplink transmission. In some embodiments, each beam group may further include two beams that may be used by the UE 110 for simultaneous reception.

For uplink based beam management, the UE 110 may transmit SRS to the gNB 120A. In this example, the network may configure two sets of SRS resources for beam management. A first SRS resource set may be configured for a first panel of the UE 110 and a second SRS resource set may be configured for a second different panel of the UE 110. This may be achieved by the networking setting one or more parameters of a first SRS-ResourceSet IE and a second SRS-ResourceSet IE to “beamManagement.”

In 415, the UE 110 transmits SRS using a first panel. In 416, the UE 110 transmits SRS using a second different panel. In some embodiments, the first panel and the second panel may transmit the same SRS resource simultaneously. In other embodiments, the first panel and the second panel may transmit separate SRS resources simultaneously.

The following exemplary techniques are introduced for spatial transmit filter (e.g., uplink beam) configuration and/or indication when the UE 110 supports transmitting the same SRS resource simultaneously from both panels. For either codebook based uplink or non-codebook based uplink, two uplink beams may be configured for the same SRS resource. For codebook based SRS transmission, a fixed SRS port to panel mapping may be specified. To provide an example, for two port SRS, port 0 may be mapped to a first uplink panel and port 1 may be mapped to a second different uplink panel. Each panel may transmit an uplink beam. Thus, the first panel may transmit a first beam using one or more SRS resources and the second panel may transmit a second beam using the same one or more SRS resources. For four port SRS, ports 0 and 2 may be mapped to a first uplink panel and ports 1 and 3 may be mapped to a second different uplink panel. Thus, the first panel may transmit a first beam using one or more SRS resources and the second panel may transmit a second beam using the same one or more SRS resources

To support multi-panel simultaneous PUSCH transmission, the following exemplary techniques are introduced when separate SRS resources are configured for each panel. In one approach, multiple panels may be mapped to the same SRS resource set. For example, an SRS-ResourceSet IE may group SRS resources into subsets for each panel. Thus, an SRS resource set may comprise a first group of SRS resources to be used by a first panel and a second group of SRS resources to be used by the second panel. The first panel and the second panel may transmit beams using the SRS resources from their respective groups simultaneously. In another approach, each panel may be mapped to a different SRS resource set. For example, a first SRS-ResourceSet IE may configure SRS resources for a first panel and a second SRS-ResourceSet IE may configure SRS resources for a second panel. The first panel and the second panel may transmit beams using SRS resources from their respective SRS resource sets simultaneously.

According to some aspects, the exemplary embodiments introduce the following power control techniques when the UE 110 supports transmitting the same SRS resource simultaneously from both panels where a different uplink beam is configured for each panel. In one approach, there may be only one power control mechanism for both panels and thus, both panels transmit at the same power. For example, there may be only one alpha and p0 parameter configured for both panels where alpha represents a partial pathloss compensation factor and p0 is targeted received energy at the gNB. In some exemplary embodiments, one pathloss reference signal (e.g., pathlossReferenceRS) may be configured for both panels. In other exemplary embodiments, different pathloss reference signals may be configured for different panels. With this approach, the UE 110 may determine the same transmit power for multiple panels based on a same pathloss measurement (e.g., worst/best, etc.). In another approach, there may be independent power control for each panel and thus, each panel may transmit at a different power. For example, there may be an independent alpha and p0 parameter configured for each panel. In addition, different pathloss reference signals may be configured for different panels.

In 420, the network schedules multi-panel simultaneous uplink transmission with SDM. For example, the network may transmit an uplink grant to the UE 110 scheduling a subsequent uplink transmission on the PUSCH. The scheduling information may indicate which uplink beams are to be used by the UE 110 for PUSCH and/or any other appropriate type of information related to the performance of PUSCH transmissions. However, the exemplary embodiments are not limited to multi-panel simultaneous uplink transmission scheduled by an uplink grant. The exemplary embodiments may utilize any appropriate signal and/or condition to trigger multi-panel simultaneous uplink transmission with SDM.

In 5G NR, to schedule PUSCH, an SRS resource indicator (SRI) may be utilized. For codebook based PUSCH operation, the SRI may indicate a selected SRS resource whose ports are to be used for precoding operations of the PUSCH transmission. For non-codebook based PUSCH operation, the SRI may indicate a selected SRS resources and ports for PUSCH transmission and the number of layers (e.g., RI). In addition, a transmit precoding matrix indicator (TPMI) may be used to schedule codebook based PUSCH. For codebook based PUSCH operation, the TPMI may indicate the TPMI and the number of layers. The following exemplary embodiments relate to SRI and/or TPMI.

According to some aspects, when the UE 110 is configured to transmit the same SRS resource simultaneously from both panels, only a single SRI may be utilized. For example, the UE 110 may transmit the corresponding PUSCH with the same two beams the UE 110 used to transmit the SRS associated with the SRI reported by the gNB 120A.

The exemplary embodiments also introduce the following exemplary techniques that may be utilized when the UE 110 is configured to separately transmit SRS resources from each panel. In this example, the gNB 120A may provide the UE 110 with two SRIs, e.g., a first SRI corresponding to one or more SRS resources transmitted by the first panel and a second SRI corresponding to one or more SRS resources transmitted by the second panel. For codebook based PUSCH operation, one SRS resource may be selected by an SRI among all of the SRS resources configured for each panel. For non-codebook based PUSCH operation, in some exemplary embodiments, the same amount of SRS resources may be selected by SRI for each panel. In other exemplary embodiments, a different amount of SRS resources may be selected by SRI for each panel.

On the network side, to support multi-panel simultaneous PUSCH transmission with SDM, the gNB 120A may be configured to toggle between different modes of operation. The mode of operation may include, but is not limited to, a first mode where the UE 110 operates with only a first panel, a second mode where the UE 110 operates with only a second different panel and a third mode where the UE 110 operates with both panels. The toggling mechanism may be achieved by DCI or a MAC-CE. For example, the UE 110 and the gNB 120A may initially configure the three different modes of operation. Subsequently, the gNB 120A may transmit DCI or a MAC-CE that selects one or more SRS-ResourceSets, one or more groups of SRS resources and/or one or more uplink beams. This may indicate to the UE 110 which mode of operation is to be utilized. For example, if the qNB 120A selects a single SRS-ResourceSet that is mapped to a first panel and a second panel or multiple SRS-ResourceSets each mapped to a different one of the panels, this may indicate to the UE 110 is to activate a mode of operation where the UE 110 utilizes multiple panels for PUSCH transmission. In another example, if the gNB 120A selects a single SRS-ResourceSet that is mapped to a single panel, this may indicate the UE 110 is to activate a mode of operation where the UE 110 only utilizes a single panel for PUSCH transmission.

To support multi-panel simultaneous PUSCH transmission with SDM, the exemplary embodiments introduce the following techniques for TPMI indication. In one approach, an independent TPMI may be used for each panel. For example, a first TPMI may be associated with a first SRS resource and indicate ports for a first panel and a second TPMI may be associated with a second SRS resource and indicate ports for the second panel. The first TPMI may support up to two layers for the first panel over two SRS ports from the first SRS resource and the second TPMI may support up to two layers for the second panel over two SRS ports for the second SRS resource. In another approach, a single TPMI may be used for multiple panels. In this example, a single TPMI may be used for up to four layers from both panels over four SRS ports. The port to panel mapping may be fixed and hard encoded in 3GPP specification. For example, ports 0 and 2 may be mapped to the first panel and ports 1 and 3 may be mapped to the second panel.

In 425, the UE 110 transmits PUSCH using a first panel. In 426, the UE 110 transmits PUSCH using a second different panel. The transmissions in 425 and 426 may be performed at the UE 110 simultaneously. This configuration and/or performance of the PUSCH transmission may be based on the exemplary techniques described throughout the signaling diagram 400.

### EXAMPLES

In a first example, a method performed by a user equipment (UE) configured with multi-panel simultaneous physical uplink shared channel (PUSCH) transmission with spatial domain multiplexing (SDM), comprising receiving sounding reference signal (SRS) configuration information from a base station, transmitting a first beam using a first panel of the UE, wherein the first beam comprises at least one of SRS or PUSCH and transmitting a second beam using a second panel of the UE, wherein the second beam comprises at least one of SRS or PUSCH and wherein the first beam and the second beam are transmitted simultaneously.

In a second example, the method of the first example, further comprising reporting UE capability information to the base station, the UE capability information indicating the UE supports transmitting SRS resources simultaneously from the first panel and the second panel.

In a third example, the method of the second example, wherein the capability information further indicates a maximum number of multiple input multiple output (MIMO) layers for PUSCH operation across the first panel and the second panel.

In a fourth example, the method of the second example, wherein the capability information further indicates a maximum number of ports for uplink transmission for each panel.

In a fifth example, the method of the second example, wherein the capability information further indicates a maximum number of ports for uplink transmission across the first panel and the second panel.

In a sixth example, the method of the first example, further comprising transmitting a group based beam report to the base station comprising multiple groups, wherein each group comprises two beams that are suitable for simultaneous downlink reception and two beams that are suitable for multi-panel simultaneous uplink transmission.

In a seventh example, the method of the first example, further comprising transmitting a group based beam report to the base station comprising multiple groups, wherein each group comprises two beams that are suitable for multi-panel simultaneous uplink transmission.

In an eighth example, the method of the first example, wherein the SRS configuration information comprises a first SRS resource set to be used by the first panel for uplink based beam management and a second SRS resource set to be used by the second panel for uplink based beam management.

In a ninth example, the method of the first example, wherein the first beam and the second based are configured to use a same SRS resource.

In a tenth example, the method of the ninth example, wherein the SRS resource is configured for codebook based SRS transmission and wherein one or more SRS ports are mapped to the first panel and one or more SRS ports are mapped to the second panel.

In an eleventh example, the method of the first example, wherein the first panel and the second panel are mapped to a same SRS resource set, the SRS resource set comprising a first group of SRS resources configured for the first panel and a second group of SRS resources configured for the second panel.

In a twelfth example, the method of the first example, wherein the first panel and the second panel are mapped to different SRS resource sets.

In a thirteenth example, the method of the first example, wherein the UE is configured to transmit a same SRS resource simultaneously from the first panel and the second panel and wherein the first panel and the second panel have a same power control.

In a fourteenth example, the method of the thirteenth example, wherein a same pathloss reference signal is configured for both the first panel and the second panel.

In a fifteenth example, the method of the thirteenth example, wherein a different pathloss reference signal is configured for both the first panel and the second panel.

In a sixteenth example, the method of the first example, wherein the UE is configured to transmit a same SRS resource simultaneously from the first panel and the second panel and wherein the first panel and the second panel have independent power control.

In a seventeenth example, the method of the first example, further comprising receiving an SRS resource indicator (SRI) from the base station, wherein the SRI corresponds to the first beam and the second beam.

In an eighteenth example, the method of the first example, further comprising receiving multiple SRS resource indicators (SRIs) from the base station, wherein a first SRI selects one SRS resource among multiple configured SRS resources for the first panel and a second SRI selects one SRS resource among multiple configured SRS resources for the second panel.

In a nineteenth example, the method of the first example, further comprising receiving multiple SRS resource indicators (SRIs) from the base station, wherein a first SRI selects a first number of SRS resources for the first panel and a second SRI selects a second number of SRS resources for the second panel, wherein the first number and the second number are a same number or a different number.

In a twentieth example, the method of the first example, further comprising receiving a medium access control (MAC) control element (CE) or a downlink control information (DCI) configured to cause the UE to toggle between different modes of operation, wherein a first operation mode comprises the UE utilizing only the first panel for uplink communication, a second operation mode comprises the UE utilizing only the second panel for uplink communication and a third operation mode comprises the UE utilizing both the first panel and the second panel for uplink communication.

In a twenty first example, the method of the first example, further comprising receiving multiple transmit precoding matrix indicators (TPMIs), wherein a first TPMI is for the first panel and a second TPMI is for the second panel.

In a twenty second example, the method of the first example, the operations further comprising receiving a single transmit precoding matrix indicators (TPMI), wherein the TPMI is for both the first panel and the second panel.

In a twenty third example, a processor of a user equipment (UE) configured to perform any of the operations of the first through twenty second examples.

In a twenty fourth example, a user equipment (UE) comprises a transceiver configured to communicate with a network and a processor communicatively coupled to the transceiver and configured to perform any of the operations of the first through twenty second examples.

In a twenty fifth example, a method performed by a base station configured to support multi-panel simultaneous physical uplink shared channel (PUSCH) transmission with spatial domain multiplexing (SDM) by a user equipment (UE), comprising transmitting sounding reference signal (SRS) configuration information to the UE, receiving a first beam from a first panel of the UE, wherein the first beam comprises at least one of SRS or PUSCH and receiving a second beam from a second panel of the UE, wherein the second beam comprises at least one or SRS or PUSCH and wherein the first beam and the second beam are transmitted simultaneously.

In a twenty sixth example, the method of the twenty fifth example, further comprising receiving UE capability information, the UE capability information indicating that the UE supports transmitting SRS resources simultaneously from the first panel and the second panel.

In a twenty seventh example, the method of the twenty sixth example, wherein the capability information further indicates a maximum number of multiple input multiple output (MIMO) layers for PUSCH operation across the first panel and the second panel.

In a twenty eighth example, the method of the twenty sixth example, wherein the capability information further indicates a maximum number of ports for uplink transmission for each panel.

In a twenty ninth example, the method of the twenty sixth example, wherein the capability information further indicates a maximum number of ports for uplink transmission across the first panel and the second panel.

In a thirtieth example, the method of the twenty fifth example, further comprising receiving a group based beam report comprising multiple groups, wherein each group comprises two beams that are suitable for simultaneous downlink reception and two beams that are suitable for multi-panel simultaneous uplink transmission.

In a thirty first example, the method of the twenty fifth example, further comprising receiving a group based beam report comprising multiple groups, wherein each group comprises two beams that are suitable for multi-panel simultaneous uplink transmission.

In a thirty second example, the method of the twenty fifth example, wherein the SRS configuration information comprises a first SRS resource set to be used by the first panel for uplink based beam management and a second SRS resource set to be used by the second panel for uplink based beam management.

In a thirty third example, the method of the twenty fifth example, wherein the first beam and the second based are configured to use a same SRS resource.

In a thirty fourth example, the method of the thirty third example, wherein the SRS resource is configured for codebook based SRS transmission and wherein one or more SRS ports are mapped to the first panel and one or more SRS ports are mapped to the second panel.

In a thirty fifth example, the method of the twenty fifth example, wherein the first panel and the second panel are mapped to a same SRS resource set, the SRS resource set comprising a first group of SRS resources configured for the first panel and a second group of SRS resources configured for the second panel.

In a thirty sixth example, the method of the twenty fifth example, wherein the first panel and the second panel are mapped to different SRS resource sets.

In a thirty seventh example, the method of the twenty fifth example, further comprising transmitting an SRS resource indicator (SRI) to the UE, wherein the SRI corresponds to the first beam and the second beam.

In a thirty ninth example, the method of the twenty fifth example, further comprising transmitting multiple SRS resource indicators (SRIs) to the UE, wherein a first SRI selects one SRS resource among multiple configured SRS resources for the first panel and a second SRI selects one SRS resource among multiple configured SRS resources for the second panel.

In a fortieth example, the method of the twenty fifth example, further comprising transmitting multiple SRS resource indicators (SRIs) to the UE, wherein a first SRI selects a first number of SRS resources for the first panel and a second SRI selects a second number of SRS resources for the second panel, wherein the first number and the second number are a same number or a different number.

In a forty first example, the method of the twenty fifth example, further comprising transmitting a medium access control (MAC) control element (CE) or a downlink control information (DCI) configured to cause the UE to toggle between different modes of operation, wherein a first operation mode comprises the UE utilizing only the first panel for uplink communication, a second operation mode comprises the UE utilizing only the second panel for uplink communication and a third operation mode comprises the UE utilizing both the first panel and the second panel for uplink communication.

In a forty second example, the method of the twenty fifth example, further comprising transmitting multiple transmit precoding matrix indicators (TPMIs) to the UE, wherein a first TPMI is for the first panel and a second TPMI is for the second panel.

In a forty third example, the method of the twenty fifth example, further comprising transmitting a single transmit precoding matrix indicators (TPMI) to the UE, wherein the TPMI is for both the first panel and the second panel.

In an forty fourth example, a processor of a base station configured to perform any of the operations of the twenty fifth through forty third examples.

In a forty fifth example, a base station comprises a transceiver configured to communicate with a user equipment (UE) and a processor communicatively coupled to the transceiver and configured to perform any of the operations of the twenty fifth through forty third examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured with multi-panel simultaneous physical uplink shared channel (PUSCH) transmission with spatial domain multiplexing (SDM), the processor configured to perform operations comprising:
receiving sounding reference signal (SRS) configuration information from a base station;
transmitting a first beam using a first panel of the UE, wherein the first beam comprises at least one of SRS or PUSCH; and
transmitting a second beam using a second panel of the UE, wherein the second beam comprises at least one of SRS or PUSCH and wherein the first beam and the second beam are transmitted simultaneously.

2. The processor of claim 1, the operations further comprising:
reporting UE capability information to the base station, the UE capability information indicating the UE supports transmitting SRS resources simultaneously from the first panel and the second panel.

3. The processor of claim 2, wherein the capability information further indicates a maximum number of multiple input multiple output (MIMO) layers for PUSCH operation across the first panel and the second panel.

4. The processor of claim 2, wherein the capability information further indicates a maximum number of ports for uplink transmission for each panel.

5. The processor of claim 2, wherein the capability information further indicates a maximum number of ports for uplink transmission across the first panel and the second panel.

6. The processor of claim 1, the operations further comprising:
transmitting a group based beam report to the base station comprising multiple groups, wherein each group comprises two beams that are suitable for simultaneous downlink reception and two beams that are suitable for multi-panel simultaneous uplink transmission.

7. The processor of claim 1, the operations further comprising:
transmitting a group based beam report to the base station comprising multiple groups, wherein each group comprises two beams that are suitable for multi-panel simultaneous uplink transmission.

8. The processor of claim 1, wherein the SRS configuration information comprises a first SRS resource set to be used by the first panel for uplink based beam management and a second SRS resource set to be used by the second panel for uplink based beam management.

9. The processor of claim 1, wherein the first beam and the second based are configured to use a same SRS resource.

10. The processor of claim 9, wherein the SRS resource is configured for codebook based SRS transmission and wherein one or more SRS ports are mapped to the first panel and one or more SRS ports are mapped to the second panel.

11. The processor of claim 1, wherein the first panel and the second panel are mapped to a same SRS resource set, the SRS resource set comprising a first group of SRS resources configured for the first panel and a second group of SRS resources configured for the second panel.

12. The processor of claim 1, wherein the first panel and the second panel are mapped to different SRS resource sets.

13. The processor of claim 1, wherein the UE is configured to transmit a same SRS resource simultaneously from the first panel and the second panel and wherein the first panel and the second panel have a same power control.

14. A processor of a base station configured to support multi-panel simultaneous physical uplink shared channel (PUSCH) transmission with spatial domain multiplexing (SDM) by a user equipment (UE), the processor configured to perform operations comprising:
transmitting sounding reference signal (SRS) configuration information to the UE;
receiving a first beam from a first panel of the UE, wherein the first beam comprises at least one of SRS or PUSCH; and
receiving a second beam from a second panel of the UE, wherein the second beam comprises at least one or SRS or PUSCH and wherein the first beam and the second beam are transmitted simultaneously.

15. The processor of claim 14, the operations further comprising:
receiving UE capability information, the UE capability information indicating that the UE supports transmitting SRS resources simultaneously from the first panel and the second panel.

16. The processor of claim 15, wherein the capability information further indicates a maximum number of multiple input multiple output (MIMO) layers for PUSCH operation across the first panel and the second panel.

17. The processor of claim 15, wherein the capability information further indicates a maximum number of ports for uplink transmission for each panel.

18. The processor of claim 15, wherein the capability information further indicates a maximum number of ports for uplink transmission across the first panel and the second panel.

19. The processor of claim 14, the operations further comprising:
receiving a group based beam report comprising multiple groups, wherein each group comprises two beams that are suitable for simultaneous downlink reception and two beams that are suitable for multi-panel simultaneous uplink transmission.

20. The processor of claim 14, the operations further comprising:
receiving a group based beam report comprising multiple groups, wherein each group comprises two beams that are suitable for multi-panel simultaneous uplink transmission.
